(19) United States
(12) Patent Application Publication
(10) Pub. No.: US 2008/0270578 A1
(43) Pub. Date: Oct. 30, 2008

(54) Method, Device And Data Download System For Controlling Effectiveness Of A Download Transaction

(75) Inventors: Lei Zhang, Shenzhen (CN); Hua Gong, Shenzhen (CN); Qitao Zhong, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD.

(21) Appl. No.: 12/170,212

(22) Filed: Jul. 9, 2008

Related U.S. Application Data
(63) Continuation of application No. PCT/CN2006/003485, filed on Dec. 19, 2006.

(30) Foreign Application Priority Data
Jan. 13, 2006 (CN) 200610001197.6

(51) Int. Cl. G06F 15/16

(52) U.S. Cl. 709/219

(57) ABSTRACT

A method, device, and data download system for controlling effectiveness of a download transaction. The method includes: resolving, by a download server, a transaction ID generation request from a download portal, dynamically generating a transaction ID according to a current download transaction and sending the transaction ID to the download portal; sending, by the download portal, a download address corresponding to a download content selected by a download client and the transaction ID to the download client; the download client redirecting to the download server according to the download address, and sending a download request containing the transaction ID; and authenticating an identity of the download client and verifying the transaction ID by the download server, if the verification is passed, transferring, by the download server, the corresponding download content to the download client; otherwise, the download fails.

### CROSS-REFERENCE TO RELATED APPLICATIONS

This application is a continuation of International Application No. PCT/CN2006/003485, filed Dec. 19, 2006. This application claims the benefit of Chinese Application No. 200610001197.6, filed Jan. 13, 2006. The disclosures of the above applications are incorporated herein by reference.

### FIELD

The present disclosure relates to the technical field of network communications and network data transfer technologies, and to a method, a device and a data download system for controlling effectiveness of a download transaction.

### BACKGROUND

With the development of information technology, people get more and more used to obtaining various data via networks. For example, the content needed is usually downloaded via a data download system.

Referring to FIG. 1, it shows a block diagram of a data download system in the prior art.

The data download system 100 includes a download client 110, a download server 120 and a download portal 130.

Wherein, download contents (such as music and pictures, etc.) are stored in the download server 120, and related information, such as the introduction of the download contents, the rate and so on, is presented via the download portal 130. The corresponding download address of the presented download content in the download server 120 is also stored in the download portal 130. The download address is usually represented by URL (Uniform Resource Locators).

Referring to FIG. 2, it shows a flow chart of the operation of the data download system shown in FIG. 1, which includes the following steps.

Step S210: a download client 110 logs in a download portal 130 and initiates a service browse request.

Step S220: the download portal 130 returns a service browse response, and the download client 110 browses the contents that can be downloaded.

Step S230: after a user selects the content to be downloaded, a download request is sent to the download portal 130.

Step S240: the download portal 130 informs the download client 110 of the download address of the download content in a download server 120.

Step S250: the download client 110 redirects the download request according to the download address informed by the download portal 130.

Step S260: the download server 120 transfers the corresponding download content to the download client 110.

Step S270: the download client 110 sends a download completion notice to the download server 120 after the content is downloaded.

Step S280: the download server 120 counts the charge of the download.

In other words, during the operation of the data download system in the prior art, the download client 110 accesses the download portal to view the introduction of the download contents. When the user is interested in a content and the rate of the content is acceptable, the user clicks the download button, and the download portal 130 informs the download client of the static download address of the download content in the download server 120. The download client 110 may directly access the download server via the static download address, and download the content to the local terminal. At this point, the download server 120 counts the download charge for the download client 110.

However, in the data download system and the download process of the prior art, when receiving a content promotion advertisement from a CP (Content Provider), the download client may directly download the content from the download server 120 without going through the download portal 130, so that the user may be misguided for consumption.

This is because some CPs send content promotion advertisements to the download client 110 for promoting their download contents, and these advertisements contain the download addresses of the download contents. If the user clicks the address, the content will be downloaded directly from the download server 120, and the user will be charged. Moreover, some CPs may send false propaganda of contents and rates to the user. Because the download server 120 cannot check the effectiveness of the download addresses, the user may be misguided for consumption.

### SUMMARY

In the embodiments, there is provided a method, a device and a data download system for controlling effectiveness of a download transaction, so that the effectiveness of a download transaction may be controlled.

An embodiment provides a method for controlling the effectiveness of the download transaction, which includes:

receiving a download request from a download client; wherein the download request contains a download address corresponding to download content selected by the download client and a transaction ID; and

verifying the transaction ID;

transferring the download content corresponding to the download address to the download client in response to the pass of the verification.

An embodiment further provides a data download system, which includes a download server communication with a download client, wherein:

the download server is adapted to resolve a download request containing a download address and a transaction ID from the download client, verify an identity of the download client and the transaction ID, and transfer a download content corresponding to the download address to the download client if the verification is passed.

An embodiment provides a data download server, including

a transaction ID verifying unit, adapted to verify a transaction ID carried in a download request when receiving the download request from the download client; and

a content downloading unit, adapted to provide the corresponding download content to the download client in response to the pass of the verification.

An embodiment further provides a data download portal device, which includes:

a content presentation unit, adapted to present related information of a download content stored in a download server;

a transaction ID requesting unit, adapted to request a transaction ID from the download server after a user selects the download content; and

a download address integrating unit, adapted to integrate the transaction ID returned by the download server into a content download address, and send to a download client.

An embodiment further provides a download client, which is configured to implement a method includes:

obtaining a transaction ID and a download address corresponding to a download content from a download portal;

sending a download request containing the download address and the transaction ID to a download server; and obtaining the download content from the download server.

In the data download system and the method for controlling the effectiveness of the download transaction according to the embodiments, there exists a transaction control mechanism, and the generation, integration, transfer and verification of the transaction ID for the download transaction may be realized by the download server and the download portal, so that the effectiveness of the download transaction may be controlled, and the static download address in the promotion advertisement of a CP is disabled, therefore the user may be prevented from being misguided for consumption.

In the embodiments, the transaction ID and the corresponding information are encrypted with a digital abstract signature, so that system security may be further improved.

Additionally, because the transaction ID further corresponds to a time effectiveness parameter and the identity of the download client corresponding to the transaction ID may be authenticated, the transaction ID obtained by some entities via masquerading as a specific download client may be further disabled, so that the overall security of the system may be improved.

### DRAWINGS

FIG. 1 is a block diagram of a data download system in the prior art;

FIG. 2 is a flow chart showing the operation of the data download system of the prior art shown in FIG. 1;

FIG. 3 is a schematic diagram of a data download system according to an embodiment;

FIG. 4 is a flow chart of the method for controlling the effectiveness of a download transaction according to an embodiment; and

FIG. 5 is a block diagram of a data download system according to an embodiment.

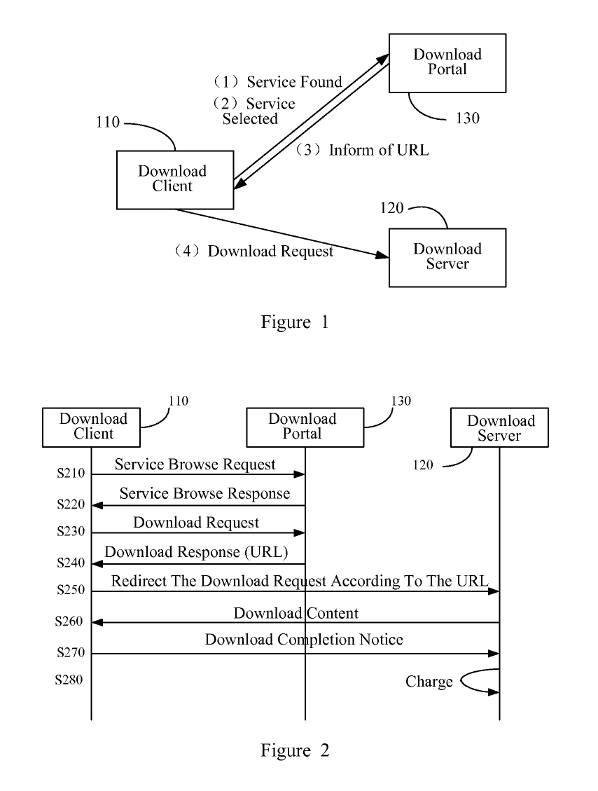

### DETAILED DESCRIPTION

For further understanding the principle, the characteristics and the advantages, it will now be described in detail in conjunction with specific embodiments.

In an embodiment, a download address, to which a dynamic transaction ID (Identity, i.e., Unique Number) is added, is provided to a download client by a download portal, and the download client can only download the content from the download server with a valid dynamic transaction ID.

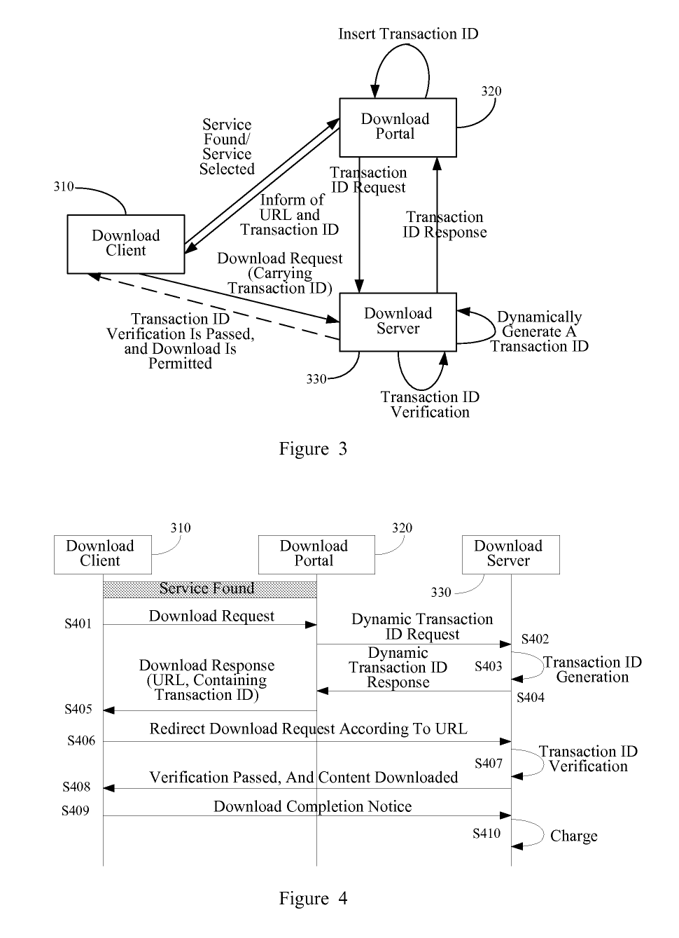

Referring to FIG. 3, it shows a schematic diagram of a data download system according to an embodiment.

The data download system includes a download client 310, a download portal 320 and a download server 330.

The download client 310 is adapted to receive the operation instruction from the user, browse related information of the download content and obtain the download address and dynamic transaction ID via the download portal 320, and obtain the download content from the download server 330.

The download portal 320 is adapted to present related information of the download content, obtain the dynamic transaction ID corresponding to the download transaction from the download server 330, and send the download address and the dynamic transaction ID to the download client 310.

The download server 330 is adapted to store the download content, send the dynamic transaction ID to the download portal 320, verify the dynamic transaction ID from the download client 310, and provide the download content to the download client 310 after the verification is passed.

Referring to FIG. 4, it shows a flow chart of the method for controlling the effectiveness of a download transaction according to an embodiment.

S401: the download client 310 finds a content to be downloaded, and sends a download request to the download portal 320 for downloading the content.

S402: the download portal 320 sends a dynamic transaction ID request to the download server 330 for applying for a dynamic transaction ID.

Wherein the dynamic transaction ID request may contain three sets of key parameters: a client number, a transaction type and a time effectiveness parameter.

S403: the download server 330 dynamically generates a transaction ID, and saves one copy locally. In an embodiment, the transaction ID may be encrypted.

Wherein, the dynamic transaction ID may be generated with various algorithms. For example, incremental algorithm may be employed, i.e., starting from 1, the subsequent transaction IDs are successively 2, 3, 4, 5, 6 . . . , as long as it is ensured that the newly generated ID is different from the previously generated IDs.

However, more complex transaction ID generation algorithm may also be employed, which will not be described in detail here.

The dynamic transaction ID generated corresponds to the above three sets of key parameters in the dynamic transaction ID request: the client number, the transaction type and the time effectiveness parameter.

The transaction ID may be encrypted in various ways. For example, digital abstract signature may be employed.

Digital abstract signature is a common method for realizing content security, wherein with public key-private key technologies in conjunction with encryption algorithms such as MD5 and so on, secure mutual access between heterogeneous entities under various application models may be realized in an open network.

A relatively simple mechanism is employed in the digital abstract signature: an irreversible encryption algorithm. After a content is encrypted by such an encryption algorithm, an attacker cannot crack the password even if the cipher key and the cipher text are obtained. The attacker can at best attempt to guess the password, so it is more difficult and takes a longer time to crack the password. As a result, system security may be protected.

S404: the download server 330 issues a dynamic transaction ID response to the download portal 320 and the dynamic transaction ID is carried in the dynamic transaction ID response.

S405: the download portal 320 integrates the transaction ID into the download address, then issues a download response to the download client 310 for informing the download client 310 of the download address.

Wherein, the process in which the transaction ID is integrated into the download address may be realized in a simple way. For example, the transaction ID string is simply spliced to a URL.

For example, the static download address is:

http://www.downloadserver.com/mms/mm001.jpg,

and the transaction ID generated by the download server 330 and sent to the download portal 320 is 195692146, then the integrated new address is:

http://www.downloadserver.com/mms/mm001.jpg;transactionID==195692146.

S406: the download client 310 redirects the download address to the download server 330 and requests to download.

S407: the download server 330 authenticates the identity of the download client 310 and verifies the transaction ID.

The download server 330 authenticates the identity of the download client 310 and verifies the transaction ID in the download address of the download client 310.

During the verification, if the transaction ID matches the local copy and the identity of the download client 310 is consistent with the identity of the download client 310 in the copy, the verification is passed.

S408: If the verification is passed, download the content to the download client 310 from the download server 330.

S409: after the content is downloaded, the download client 310 issues a download completion notice to the download server 330.

S410: the download server 330 counts the charge of this download.

In the above embodiments, after a user selects a content to be downloaded, the download portal 320 does not directly inform the download client 310 of the static URL address of the download content. Instead, the download portal 320 first applies to the download server 330 for a dynamic transaction ID. After the download server 330 receives the request, it dynamically generates a transaction ID according to three sets of key parameters (the download client number, the transaction type and the time effectiveness parameter) in the request, and encrypts the transaction ID, then returns the transaction ID to the download portal 320 and saves a copy in the download server 330 locally. The download portal 320 informs the download client 310 after inserting the transaction ID into the download address, and the download client 310 requests to download from the download server 330 based on the download address inserted the transaction ID. The download server 330 authenticates the identity of the download client 310 and verifies the transaction ID in the download address. If the transaction ID matches the local copy and the identity of the download client 310 is consistent with the identity of the download client 310 in the copy, the verification is passed and the download is permitted; otherwise, the verification fails and the download is denied.

In such a mechanism, the static download address in the promotion advertisement of a CP will be disabled, because the transaction ID verification performed by the download server cannot be passed.

Even if a few CPs try to first apply for a transaction ID by masquerading as the identities of specific download clients and then to send advertisements of specific purpose, it may fail because of the time effectiveness parameter contained in the transaction ID and the authentication on the identity of the download client performed by the download server.

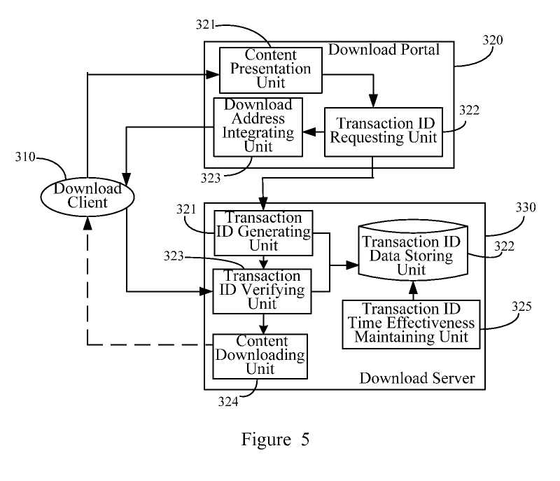

Referring to FIG. 5, it shows a block diagram of the data download system according to an embodiment.

The data download system includes a download client 310, a download portal 320 and a download server 330, wherein:

the download portal 320 includes a content presenting unit 321, a transaction ID requesting unit 322 and a download address integrating unit 323.

The content presentation unit 321 is adapted to present related information of download contents stored in the download server 330.

The transaction ID requesting unit 322 is responsible for requesting a dynamic transaction ID from the download server 330 after a user selects a download content.

The download address integrating unit 323 is responsible for integrating the dynamic transaction ID into the content download address after the download server 330 returns the dynamic transaction ID, and then informing the download client 310.

The download server 330 includes a transaction ID generating unit 331, a transaction ID data storing unit 332, a transaction ID verifying unit 333, a content downloading unit 334 and a transaction ID time effectiveness maintaining unit 335.

The transaction ID generating unit 331 is responsible for dynamically generating a transaction ID and encrypting it when the download server 330 receives a dynamic transaction ID request from the download portal 320, then returning the transaction ID to the download portal 320 and saving a copy of the transaction ID in the transaction ID data storing unit 332;

The transaction ID verifying unit 333 is responsible for verifying the transaction ID carried in the download instruction when the download server 330 receives the download request from the download client 310, and during the verification, the local copy saved in the transaction ID data storing unit 332 needs to be accessed;

The content downloading unit 334 provides the corresponding download content to the download client 310 when the verification on the transaction ID is passed;

The transaction ID time effectiveness maintaining unit 335 is adapted to maintain the data in the transaction ID data storing unit 332, wherein the utmost task is to clear outdated transaction IDs.

The transaction ID time effectiveness maintaining unit 335 may be triggered at scheduled time (for example, once every minute). Each time it is triggered, the whole transaction ID data storing unit 332 will be run over, and each outdated transaction ID will be cleared once it is found.

In the data download system and the method for controlling the effectiveness of the download transaction described herein, a dynamic transaction control mechanism is added between the download portal and the download server, and the transaction content is encrypted via the digital abstract signature, so that the download address in the promotion advertisement of a CP may be disabled, and the user may be prevented from being misguided by the promotion advertisement of a CP and generating “undeserved” consumption. As a result, benefit of the user may be protected, the probability of user complaints may be reduced, and the Quality of Service of providers may be improved.

Additional advantages and modifications will readily occur to those skilled in the art. Therefore, the disclosure in its broader aspects is not limited to the specific details and representative embodiments shown and described herein. Accordingly, various modifications and variations may be made without departing from the spirit or scope of the disclosure as defined by the appended claims and their equivalents.

What is claimed is:

1. A method for controlling effectiveness of a download transaction, comprising:
receiving a download request from a download client; wherein the download request contains a download address corresponding to download content selected by the download client and a transaction ID;
verifying the transaction ID; and
transferring the download content corresponding to the download address to the download client in response to the pass of the verification.

2. The method for controlling effectiveness of a download transaction according to claim 1, further comprising:
verifying an identity of the download client, wherein the pass of the verification comprises the pass of verifying the identity.

3. The method for controlling effectiveness of a download transaction according to claim 2, further comprising:
resolving, a transaction ID generation request from a download portal,
generating the transaction ID according to a current download transaction; and
sending the transaction ID to the download client via the download portal.

4. The method for controlling effectiveness of a download transaction according to claim 3, wherein the process of sending the transaction ID to the download client via the download portal comprises:
sending the transaction ID to the download portal; and
integrating, by the download portal, the transaction ID into the download address and sending the download address contained the transaction ID to the download client.

5. The method for controlling effectiveness of a download transaction according to claim 2, further comprising:
storing a copy of the transaction ID generated in the download server;
wherein the process of verifying comprises:
determining whether the transaction ID from the download client is consistent with the copy of the transaction ID generated; and
determining whether the download client number is consistent with a client number corresponding to the copy of the transaction ID generated.

6. The method for controlling effectiveness of a download transaction according to claim 3, wherein the download server generates the transaction ID based on a download client number, a transaction type and a time effectiveness parameter provided by the download portal

7. The method for controlling effectiveness of a download transaction according to claim 6, further comprising: verifying the time effectiveness parameter corresponding to the transaction ID, wherein the pass of the verification comprises the pass of verifying the time effectiveness parameter.

8. The method for controlling effectiveness of a download transaction according to claim 4, further comprising: encrypting the transaction ID with a digital abstract signature.

9. The method for controlling effectiveness of a download transaction according to claim 4, wherein the download address is a URL address, and the process of integrating the transaction ID into the download address comprises splicing the transaction ID string to the URL.

10. A data download system, comprising a download server communication with a download client, wherein:
the download server is adapted to resolve a download request containing a download address and a transaction ID from the download client, verify an identity of the download client and the transaction ID, and transfer a download content corresponding to the download address to the download client if the verification is passed.

11. The data download system according to claim 10, further comprising a download portal; wherein the download portal is adapted to resolve instructions from the download client for selecting the download content, obtain the transaction ID corresponding to a download transaction from the download server, and send the download address corresponding to the download content selected by the download client and the transaction ID to the download client; and
wherein the download server is further adapted to resolve the transaction ID generation request from the download portal, generate the transaction ID according to the download transaction and send the transaction ID to the download portal.

12. A data download server, comprising:
a transaction ID verifying unit, adapted to verify a transaction ID carried in a download request when receiving the download request from the download client; and
a content downloading unit, adapted to provide the corresponding download content to the download client in response to the pass of the verification

13. The data download server according to claim 12, further comprising:
a transaction ID generating unit, adapted to generate the transaction ID upon receiving a transaction ID generation request from a download portal, and return the transaction ID to the download portal; and
a transaction ID data storing unit, adapted to store a copy of the transaction ID generated by the transaction ID generating unit.

14. The data download server according to claim 13, further comprising:
a transaction ID time effectiveness maintaining unit, adapted to maintain the data in the transaction ID data storing unit.

15. A data download portal device, comprising:
a content presentation unit, adapted to present related information of a download content stored in a download server;
a transaction ID requesting unit, adapted to request a transaction ID from the download server after a user selects the download content; and
a download address integrating unit, adapted to integrate the transaction ID returned by the download server into a content download address, and send to a download client.

16. A download client, configured to implement a method comprising:
obtaining a transaction ID and a download address corresponding to a download content from a download portal;
sending a download request containing the download address and the transaction ID to a download server; and
obtaining the download content from the download server.
